(19) United States
(12) Patent Application Publication
(10) Pub. No.: US 2004/0120615 A1
(43) Pub. Date: Jun. 24, 2004

(54) Non-rotating bushing for actuator shaft

(75) Inventor: Wylie Robert Chase, Waterford, MI (US)

Correspondence Address: WOOD, HERRON & EVANS, LLP, 2700 CAREW TOWER, 441 VINE STREET, CINCINNATI, OH, 45202, US

(73) Assignee: Savair, Inc., Chesterfield, MI (US)

(21) Appl. No.: 10/328,484

(22) Filed: Dec. 23, 2002

(51) Int. Cl. F16C 33/00

(52) U.S. Cl. 384/42

(57) ABSTRACT

A shaft bushing for an actuator cylinder includes a removeable, non-cylindrical lined sleeve bearing configured to a flat sided shaft. Interlocking inserts are captured in windows in the outer bushing wall. These engage flat outer sides of the bearing and keep it and the shaft from rotating. A shaft wiper secures the sleeve bearing but is removable for replacement of the bearing.

This invention relates to shaft bushings for actuator cylinders and more specifically to bushings for preventing shaft rotation in pneumatic, hydraulic and electric actuator cylinders.

In the past, front end shaft bushings for actuator cylinders have been manufactured using, in part, a broaching operation to form a shaft bore conforming to the cross-section of a flat-sided reciprocating shaft in order to keep the shaft from rotating. This broaching process typically added time and cost to the manufacturing operation. Also, the front end of such cylinders through which the shaft extended in the bushing typically had no shaft bearing. Actuator reliability and bushing life were limited.

Accordingly, it has been one objective of this invention to provide an improved, anti-rotate shaft bushing for an actuator cylinder.

Another objective of the invention has been to provide an improved method of replacing wear parts in an actuator shaft bushing.

Another objective of the invention has been to improve the reliability of an actuator shaft bushing.

### SUMMARY OF THE INVENTION

To these ends, a bushing according to a preferred embodiment of the invention comprises an elongated bushing member, an elongated, non-cylindrical shaft bearing sleeve, two synthetic inserts captured in respective windows in the bushing member and having flat inner sides engaging flat outer sides of the bearing sleeve, and a wiper removeably securing the bearing sleeve within the bushing sleeve. Since the bearing sleeve cannot rotate in the bushing sleeve due to the interference of the captured inserts, and since the non-cylindrical inner bore of the bearing sleeve conforms to the flat-sided actuator shaft, that shaft is held against rotation by the bushing. The bearing sleeve is easily formed of thin gauge metal with a synthetic bearing liner, for example, rendering any broaching operation unnecessary, while retaining the anti-rotating feature for shaft control and while providing a sliding, wear resistant bearing for the shaft.

When tolerances enlarge, due to wear, for example, the wiper can be removed from the bushing, the bearing sleeve pulled out and replaced, along with insert replacement if needed, without requiring an entire new bushing or shaft. The wiper, or a new one, is replaced, securing the bearing sleeve in the bushing.

This new bushing provides significant cost, manufacturing, operating life and reliability to actuator cylinders, and is easily refitted when worn. Reliability and maintainability are improved, and manufacturing costs reduced.

These and other advantages will become readily apparent from the following detailed written description and from the drawings in which:

### DESCRIPTION OF THE DRAWINGS

FIG. 1 is a side view in partial cross-section of an assembled bushing according to the invention;

FIG. 1A is an end view of FIG. 1;

FIG. 2 is a side view in partial cross-section of the elongated bushing member of FIG. 1;

FIG. 2A is an end view of FIG. 2;

FIG. 3 is a side view of a shaft bearing;

FIG. 3A is an end view of the shaft bearing of FIG. 3;

FIG. 4 is a side view of an insert;

FIG. 4A is an end view of two inserts as they reside in a bushing according to the invention;

FIG. 5 is a side view of a shaft wiper;

FIG. 5A is an end view of the wiper of FIG. 5;

FIG. 6 is a side view of the shaft bearing of FIG. 3;

FIG. 6A is an end view of the apparatus of FIG. 6; and

FIG. 7 is a cross-sectional view taken along lines 7-7 of FIG. 1.

### DETAILED DESCRIPTION OF THE INVENTION

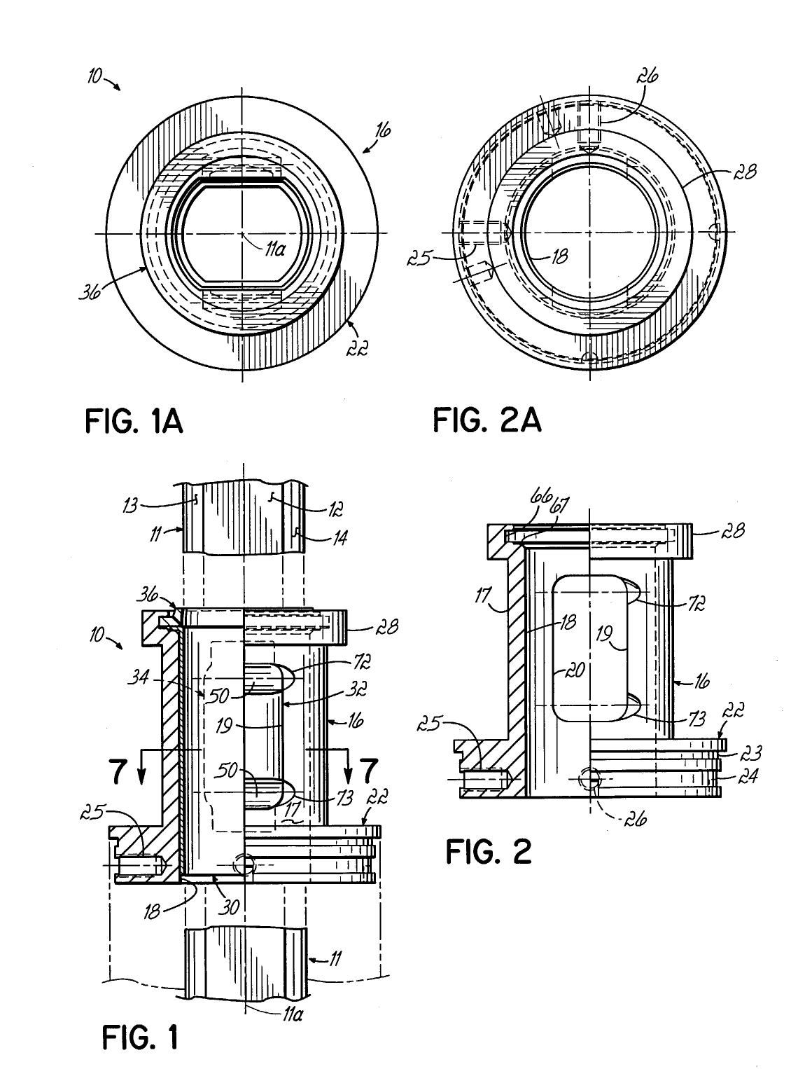

Turning now to the drawings, there is shown therein an improved bushing 10 for supporting a reciprocating shaft and preventing rotation thereof. The bushing 10 can be used effectively in conjunction with shafts, such as a flat sided shaft 11 (FIG. 1) of a pneumatic, hydraulic or electric actuator cylinder. Shaft 11 has a longitudinal axis 11a.

Bushing 10 has a particularly useful application where the shaft 11 has two opposed flat sides 12 (one not shown) and two opposed rounded sides 13, 14.

As shown in the respective Figs., bushing 10 comprises a plurality of parts including an elongated cylindrical bushing wall or member 16 having external cylindrical wall surface 17 and cylindrical internal wall surface 18 (FIG. 12). Opposed windows 19 and 20 are defined in the bushing wall 16 as shown. At one end of bushing wall 16 is a radially outwardly projecting flange 22 having seal grooves 23, 24 therein for receiving O-ring seals to seal the bushing 10 within an actuator cylinder (not shown) for example. Set screw bores 25, 26 are provided in flange 22 to secure the bushing 10 in place in such a cylinder. Bushing 10 further includes a radially outwardly projecting flange 28 at the other end of member 16. A radial groove 66 is disposed in the flange 28, as will be described, and it terminates at a lower side with a sealing shoulder 67.

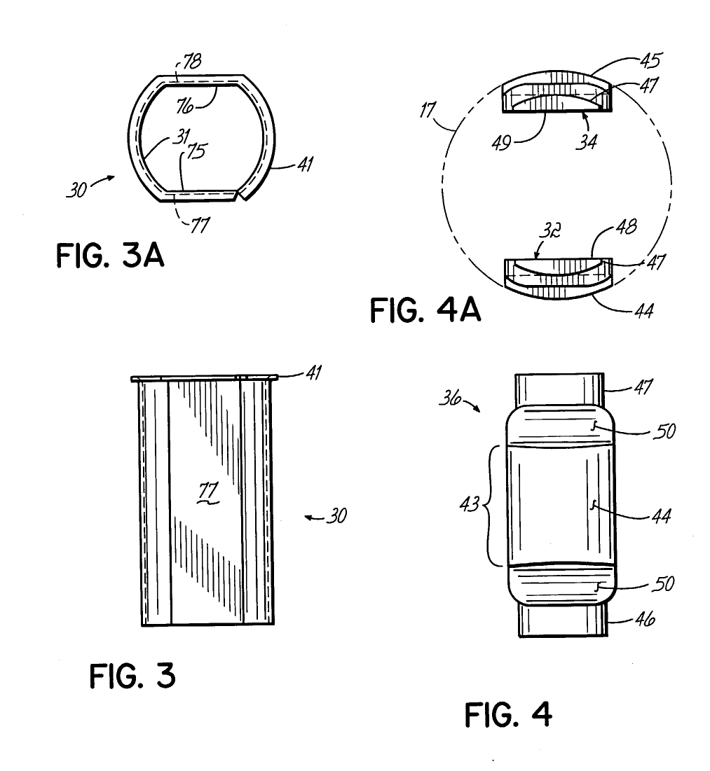

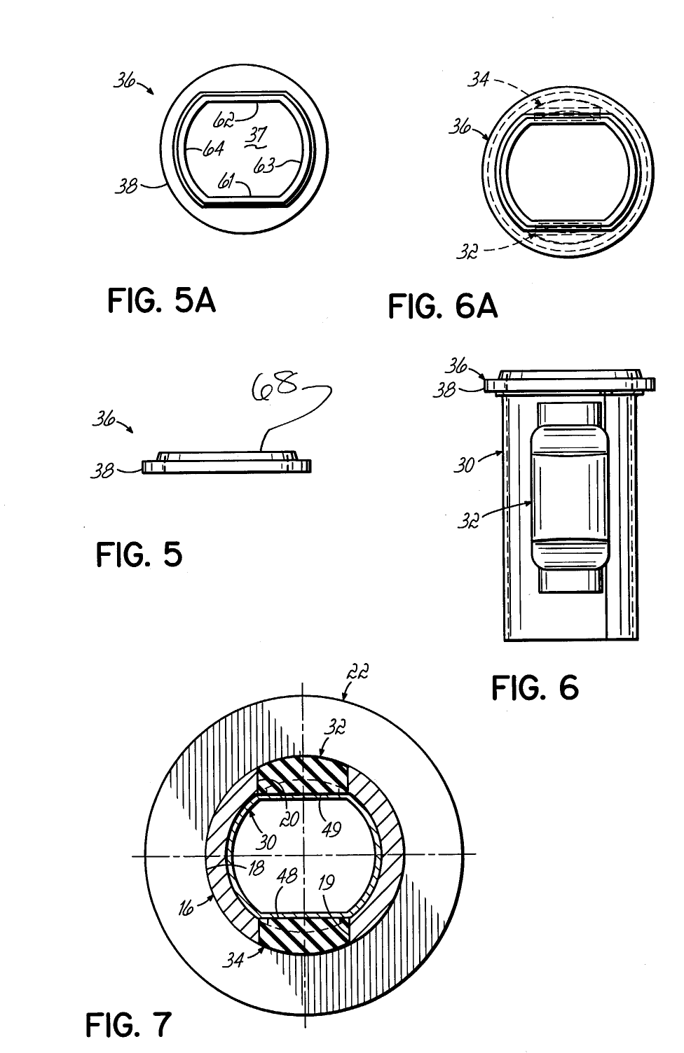

The assembled bushing 10 also has the following elements: a lined, non-cylindrical shaft sleeve bearing 30 (FIG. 3); two inserts 32, 34; and a shaft wiper and bearing retainer 36.

The lined, non-cylindrical shaft sleeve bearing 30 is preferably formed of a suitable metal and is lined with a liner 31 of preferably synthetic, wear-resistant material such as polytetrofluoroethylene or any other wear resistant surface on which a shaft 11 can slide. Liner 31 is applied by any suitable method. Bearing 30 has a radially outwardly extending flange 41 at one end thereof, interior flat sides 75, 76 and exterior flat sides 77 and 78.

Inserts 32, 34 are also made, preferably of a shear resistant synthetic material of any suitable type. Each insert has an elongated intermediate portion 43 and rounded portions 44, 45 with extending thin ends 46, 47. Inserts 32, 34 each have an inwardly facing flat face surface 48, 49, and each has two parallel grooves 50 proximate each end extending across the rounded surfaces 44, 45.

Shaft wiper 36 also functions as a bearing retainer as will be described. The wiper 36 is received within groove 66 after sleeve 30 is inserted, thereby securing the sleeve bearing 30 in the bushing 10. Alternately, the wiper could be screwed or otherwise fastened onto the end of bushing 10.

Wiper 36 has an internal opening 37 defined by two opposed flat sides 61, 62 and two opposed rounded sides 63, 64 for accommodating a shaft 11 and wiping it clean as it reciprocates therein. An upward shaft wiper projection 68 of the wiper 36 extends away from the bushing while a flat under surface 38 sealingly engages surface 67 in bushing 10 at flange 28, and the upper end of the flange 41 of the shaft sleeve bearing 30.

Assembly of the entire bushing 10 is accomplished by inserting inserts 32, 34 into windows 19, 20 from inside the cylindrical bore formed by wall surface 18. Ends 46, 47 extend along interior walls 18 while rounded portions 44, 45 extend into the windows 19, 20 in the wall 16. Grooves 50 of the inserts align with grooves 72, 73 and provide transverse passages for bolts or screws mounting any yoke or other bushing or actuator structure on the bushing 10.

After insertion of the inserts 32, 34, the non-cylindrical sleeve bearing 30 is inserted into the bore defined by interior surfaces 18 of wall 16, with the flat sides 77, 78 of the bearing 30 aligned with the flat surfaces 48, 49 (FIG. 4A) of the inserts 32, 34. The inserts are captured in the windows 19, 20 with ends 46, 47 disposed between the wall 18 just externally of the flat side 77, 78 of bearing 30 (FIG. 7).

In this manner, it will be appreciated that the flat exterior sides 77, 78 of the non-cylindrical sleeve bearing 30 are engaged by the inserts 32, 34. Since the inserts are captured, however, in the discrete windows 19, 20, they block any rotational movement of the bearing 30, such as about a shaft axis 11a.

Thereafter, the wiper 36 is secured within groove 66 and this holds the sleeve bearing 30 in place against longitudinal movement.

The assembled bushing 10 is then positioned over a shaft 11 and slid into position to be secured at one end of an actuator, or is secured thereto, awaiting introduction of a shaft 11. The flat sides 12 of the shaft 11 align with the flat surfaces 75, 76 of non-cylindrical sleeve bearing 30 which slidably supports the shaft 11, but maintains it against rotation about axis 11a.

Accordingly, it will be appreciated that the bushing 10 can be more inexpensively and quickly made than in the past; broaching to accommodate the shaft cross-section is not necessary. Moreover, any wear is accommodated by removal of bushing 10 and replacing only the lined, non-cylindrical bearing sleeve 30, and perhaps the inserts 32, 34, so the entire bushing is inexpensively refitted without an entirely new bushing being required. Since the shaft is harder than the bearing liner 31, the shaft life is extended.

These and other advantages and modifications will be readily apparent to those of ordinary skill in the art without departing from the scope of the invention and applicant intends to be bound only by the claims appended hereto.

What is claimed is:

1. A bushing for a reciprocating flat-sided shaft defining an elongated axis, said bushing comprising:
an elongated bushing member having a bushing wall;
a shaft sleeve bearing having at least one flat external surface and at least one flat internal surface for slidingly engaging a flat side of said shaft;
said wall of said bushing defining at least one insert opening therein,
an insert having a flat side for engaging the flat external surface of said shaft sleeve bearing;
said insert being disposed in said insert opening of said bushing wall and engaging said flat surface of said shaft sleeve bearing when said bearing is operatively disposed in said elongated bushing;
said bushing insert opening, said insert therein, and said shaft sleeve bearing supporting said shaft and preventing said shaft from rotating about its axis, while said shaft is free to slide and reciprocate in said shaft sleeve bearing.

2. A bushing as in claim 1 further including a wiper secured to said bushing engaging and holding said shaft sleeve bearing therein.

3. A bushing as in claim 2 including an annular groove proximate one end of said bushing, said wiper captured within said groove.

4. A bushing as in claim 1 wherein said inserts have end tabs disposed between said shaft sleeve bearing and an inner surface of said bushing wall.

5. A bushing as in claim 4 including first transverse grooves in an outer surface of said bushing wall and second transverse grooves in said insert aligned with aid first transverse grooves.

6. A bushing for a reciprocating flat-sided shaft, said bushing comprising:
an elongated bushing having a window therein;
a shaft bearing having a flat external surface and a flat internal surface;
an insert disposed in said window and engaging said shaft bearing along said flat external surface;
a flat side of said shaft engaging a flat internal surface of said shaft bearing;
said insert preventing rotation of said shaft bearing.

7. A bushing as in claim 6 wherein said insert is captioned in said window and prevents rotation of said shaft.

8. A bushing as in claim 6 further including shaft wiper disposed at an end of said rod bearing.

9. A bushing as in claim 8 wherein said wiper is removeably secured to said elongated bushing and prevents movement of said shaft bearing from said bushing.

10. A bushing as in claim 6 wherein said window is defined in a wall of said bushing having a cross-section similar to that of said insert.

11. A bushing as in claim 10 wherein said insert is of a synthetic material supporting said shaft bearing.

12. A bushing as in claim 11 wherein said insert comprises an elongated member having projections at each end extending along an interior bore of said elongated bushing.

13. A bushing as in claim 6 wherein said shaft bearing comprises a bearing member and a liner for slidably supporting a shaft.

14. A bushing as in claim 6 wherein said bushing comprises an extended cylindrical side wall in which said window is defined and a radially projecting end flange at one end and outwardly of said side wall.

15. A bushing as in claim 6 wherein said bushing comprises an extended cylindrical side wall having a cylindrical opening therethrough and further wherein said shaft bearing has a bore therethrough defined by both cured and flat interior side walls.

16. A bushing as in claim 15 wherein said shaft bearing flat exterior surface is aligned with said insert in said window.

17. An improved anti-rotate bushing for an actuator cylinder having an extensible shaft with a predetermined cross-section of two opposed flat sides and two opposed rounded sides, said bushing comprising:
an elongated bushing sleeve having a cylindrical sleeve wall and a cylindrical bore therethrough;
a shaft bearing sleeve having two opposed flat outer sides and two opposed rounded outer sides, said bearing sleeve having two opposed flat internal bore surfaces and two opposed rounded internal bore surfaces, said internal bore surfaces approximating a cross-sectional shape of said shaft and having a bearing liner thereon,
at least two windows defined in the sleeve wall of said bushing;
at least an anti-rotate insert captured in each window, said inserts each having a flat side directed inwardly of said windows aligned with a respective opposed flat external surface of said shaft bearing sleeve, said inserts engaging said sleeve and preventing rotation thereof;
said sleeve bearing opposed flat internal bore surfaces engaging respective flat sides of said shaft and preventing said shaft from rotating with respect to said shaft bearing sleeve, and said bushing sleeve.

18. A bushing sleeve as in claim 17 further including a shaft bearing sleeve retainer secured to an end of said bushing sleeve and removeably holding said bearing sleeve in said bushing sleeve.

19. A method of refitting a bushing for a reciprocal flat-sided shaft wherein said bushing comprises a wall defining a window, a shaft bearing having an external and an internal flat surface, an insert in said window aligned with a flat external surface of said shaft bearing, and a shaft wiper, said method including the steps of:
removing said wiper from said bushing;
sliding said shaft bearing out of said bushing;
sliding a new shaft bearing into said bushing with a flat external surface aligned with said insert; and
replacing said wiper.

20. A method as in claim 19 including the further steps of removing said insert and inserting a new insert before sliding a new shaft bearing into said bushing.
